(19) United States
(12) Patent Application Publication
(10) Pub. No.: US 2006/0269112 A1
(43) Pub. Date: Nov. 30, 2006

(54) Medical report preparing system and ultrasound diagnostic apparatus incorporating the system

(76) Inventor: Masumi Ochi, Sakura-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/443,088

(22) Filed: May 31, 2006

(30) Foreign Application Priority Data
May 31, 2005 (JP) 2005-159614

(51) Int. Cl. G06K 9/00; G06F 19/00

(52) U.S. Cl. 382/128; 705/3

(57) ABSTRACT

Preparation of a detailed report schema is enabled speedily and easily by deforming a schema prototype registered in advance. In the case of using a single-layered prototype, a drag and drop operation or the like is made for the prototype while pointing a cursor, for example, to a desired position, thereby deforming the prototype and preparing the report schema. In addition, in the case of using a multi-layered prototype having laminated graphics in which different colors or the like are assigned to layers, the respective layers are associated with characterizing portions of diagnostic sites, and the prototypes in the respective layers are deformed to be associated with the corresponding portions. In this manner, the prototypes are deformed, and the report schema is prepared.

### CROSS-REFERENCE TO RELATED APPLICATIONS

This application is based upon and claims the benefit of priority from prior Japanese Patent Application No. 2005-159614, filed May 31, 2005, the entire contents of which are incorporated herein by reference.

### BACKGROUND OF THE INVENTION

1. Field of the Invention

The present invention relates to a medical report preparing system or the like for preparing a medical report based on an image acquired by medical imaging equipment represented by an ultrasound diagnostic apparatus, for example.

2. Description of the Related Art

In recent years, diagnosis utilizing a medical image (medical imaging diagnosis) has been prevailingly known. In this medical imaging diagnosis, an image is acquired by means of a variety of inspecting apparatuses (modalities) such as an ultrasonic diagnostic apparatus, an X-ray CT apparatus, and a magnetic resonance imaging apparatus (MRI), and a doctor or the like who reads an image observes the acquired image, whereby diagnosis is executed. An observation result is recorded by a report preparing system in the form of a medical report defining findings such as a suspected abnormal site and the name of disease. Such a medical report is prepared by hand writing of a doctor who reads an image or by making an entry using a word processor. In addition, such a report is sometimes prepared as an electronic chart that achieves supplying of information utilizing a network.

In general, a chart called a schema is entered in or attached to this medical report. The schema used here is provided as a chart schematically depicting morphology (such as shape, color, or pattern) of a diagnostic object (such as carotid arteries, peripheral blood vessels, or heart) of the subject in imaging diagnosis. In preparation of a report using modalities such as a conventional report preparing system or modalities such as an ultrasound diagnostic apparatus, in the case of making an entry into a report, the state of blood vessels, the morphology of the heart or the like is written by hand. In addition, in the case of a digitized report, an entry is made by carrying out hand writing or making a selection from a plurality of typical schema patterns.

However, in the conventional preparation of a report, for example, the following problems occur.

First, in the preparation of a report in the conventional system that is not digitized, a chart of blood vessels or the like is prepared by carrying out hand writing while checking a diagnostic image. Thus, a work load on a person who prepares a report is significantly large, and a large amount of time is required for preparation of a report.

Second, in preparation of a report in a conventional system that is digitized, a report drawing is prepared by hand writing using drawing software or by making a selection from a plurality of typical (predetermined) schema patterns. In such a case as well, there is a need for selecting an adaptive schema from a large amount of schemas. Thus, a work lead on a person who prepares a report is significantly large and a large amount of time is required for the preparation of the report.

### BRIEF SUMMARY OF THE INVENTION

The present invention has been made in view of the foregoing circumstance. It is an object of the present invention to provide a medical report preparing system and an ultrasonic diagnostic apparatus incorporating the system capable of easily and speedily achieving preparation of a medical report as compared with a conventional system and apparatus.

According to an aspect of the present invention, there is provided a medical report preparing system, comprising: a display unit which displays a prototype of a predetermined schema with respect to a variety of diagnostic objects; an input unit to input a command for deforming the displayed prototype; a generating unit which generates a report schema by deforming the displayed prototype, based on the command; and a storage unit which stores the generated report schema to be associated with a medical report.

According to another aspect of the present invention, there is provided a medical report preparing method, comprising: displaying a prototype of a predetermined schema with respect to a variety of diagnostic objects; generating a report schema by deforming the displayed prototype based on a command for deforming the displayed prototype; and storing the generated report schema to be associated with a medical report.

According to yet another aspect of the present invention, there is provided an ultrasound diagnostic apparatus, comprising: a display unit which displays a prototype of a predetermined schema with respect to a variety of diagnostic objects; an input unit to input a command for deforming the displayed prototype; a generating unit which generates a report schema by deforming the displayed prototype, based on the command; and a storage unit which stores the generated report schema to be associated with a medical report.

According to yet another aspect of the present invention, there is provided a system for generating medical report enabling the computer system, comprising: a computer code device configured to display a prototype of a predetermined schema with respect to a variety of diagnostic objects; a computer code device configured to input a command for deforming the displayed prototype; a computer code device configured to generate a report schema by deforming the displayed prototype, based on the command; and a computer code device configured to store the generated report schema to be associated with a medical report.

### BRIEF DESCRIPTION OF THE SEVERAL VIEWS OF THE DRAWING

FIG. 1 is a block diagram depicting a configuration of a medical report preparing system 1 according to the present embodiment;

FIG. 2 is a view for explaining a concept of a schema editing processing operation using a single-layered prototype;

FIG. 3 is a view for explaining a concept of a schema editing processing operation using a single-layered prototype;

FIG. 4 is a view for explaining a concept of a schema editing processing operation using a multi-layered prototype;

FIG. 5A is a view for explaining an example of a concept of a schema editing processing operation using a multi-layered prototype;

FIG. 5B is a view for explaining another example of a concept of a schema editing processing operation using a multi-layered prototype;

FIG. 5C is a view for explaining yet another example of a concept of a schema editing processing operation using a multi-layered prototype;

FIG. 6 is a view for explaining a cross section preparing processing operation executed by a schema editing function;

FIG. 7 is a flow chart showing a flow of processing operations, each of which is executed in preparation of a report that includes a schema editing processing operation; and

FIG. 8 is a flow chart showing a flow of a schema preparing processing operation in step S6.

### DETAILED DESCRIPTION OF THE INVENTION

Now, embodiments of the present invention will be described with reference to the accompanying drawings. In the following description, like constituent elements having substantially identical functions and configurations are designated by like reference numerals. A duplicate description is given only if necessary.

In addition, the present embodiment describes an example of a medical report preparing system serving as a single apparatus connected to medical imaging equipment via a network. However, without being limited thereto, a technical idea of the present invention may be achieved by medical imaging equipment such as an ultrasonic diagnostic apparatus, a magnetic resonance imaging apparatus, an X-ray computerized tomographic imaging apparatus, and an X-ray diagnostic apparatus for use in a cardiac catheter technique that incorporates the system (or that achieves identical functions as the system). In addition, programs that execute identical functions to the medical report preparing system are installed in a computer such as a medical workstation, and these programs are extended on a memory, thereby making it possible to achieve the above described technical idea. At this time, the programs that cause a computer to execute the technique can be distributed by storing them in a recording medium such as a magnetic disk (such as a floppy disk (registered trademark) or a hard disk), an optical disk (such as CD-ROM or DVD), or a semiconductor memory.

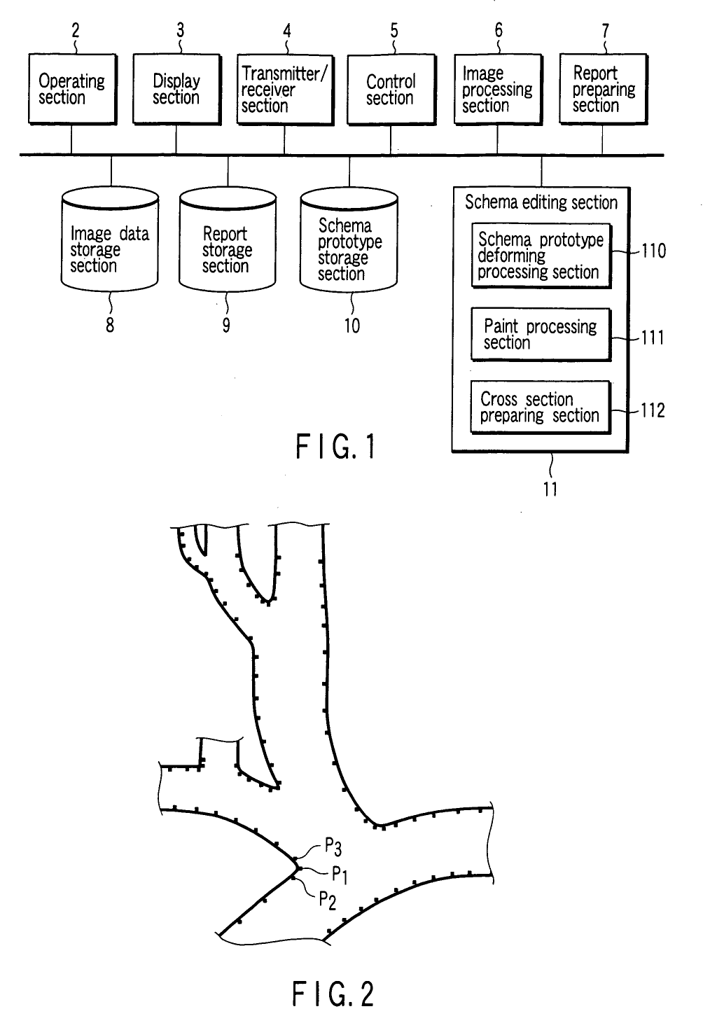

FIG. 1 is a block diagram depicting a configuration of a medical report preparing system 1 according to the present embodiment. As shown in the figure, this medical report preparing system 1 comprises: an operating section 2; a display section 3, a transmitter/receiver section 4; a control section 5; an image processing section 6; a report preparing section 7; an image data storage section 8; a report storage section 9; a schema prototype storage section 10; and a schema editing section 11.

The operating section 2 has a trackball, a variety of switches, a mouse, and a key board or the like, for capturing a variety of commands and conditions or the like from an operator to the system 1.

The display section 3 displays an image, a report input screen, and an input screen for making a predetermined operation (for example, a schema preparing screen described layer) or the like in a predetermined mode.

The transmitter/receiver section 4 transmits or receives information that includes image data to or from another apparatus via a network.

The control section 5 dynamically or statistically controls units, each of which configures the medical report preparing system 1. In particular, the control section 5 integrally controls the schema prototype storage section 10, the schema preparing section 11, the operating section 2, and the display section 3 or the like in a schema editing processing operation described later.

The image processing section 6 applies a predetermined image processing operation according to a diagnostic purpose to images acquired in a variety of medical imaging equipment, based on a command from a doctor or the like who reads an image, the command being inputted from the operating section 2. An image for use in image diagnosis (a diagnostic image) is generated by means of this image processing operation at the image processing section 6.

The report preparing section 7 prepares a medical report indicating findings from the doctor who reads the image, based on an observation result of the diagnostic image by the doctor who reads the image being inputted from the operating section 2.

The image data storage section 8 stores a variety of image data acquired via a network by means of the transmitter/receiver section 4 or image data acquired via a removable storage medium.

The report storage section 9 stores a report prepared by the report preparing section 7, a report prepared in the past, a report acquired via the transmitter/receiver section 4 or the like.

The schema prototype storage section 10 stores a prototype of a schema (a schema prototype) relating to a variety of diagnostic sites (i.e., an image reading site targeted for preparation of a report). The schema prototypes stored in this schema prototype storage section 10 can be roughly classified into a single-layered prototype and a multi-layered prototype. The single-layered prototype is made of a graphics having a single-layered structure showing at least a shape of a diagnosis target. In addition, the multi-layered prototype has a multi-layered structure having laminated therein graphics showing at least a shape of a diagnosis target, and colors or patterns different from each other are assigned. The single-layered prototype and the multi-layered prototype are used according to their purposes. A detailed description will be given later with a schema editing processing operation using these prototypes.

The schema editing section 11 executes a schema editing processing operation using a single-layered prototype and a multi-layered prototype. This editing section has: a schema prototype deforming processing section 110 that applies a deforming processing operation to a schema prototype; a paint processing section 111 that applies a paint processing operation to a schema prototype or a deformed schema prototype; and a cross section preparing section 112 that prepares a schema relating to a cross section of a diagnostic target. The schema editing section 11 prepares a report schema described in or attached to a medical report by carrying out editing made of a deforming processing operation and a paint processing operation to a schema prototype in each constituent element. Now, constituent elements that the schema editing section 11 has will be described here.

The schema prototype deforming processing section 110 executes a deforming processing operation for deforming a prototype, the prototype being read out from the schema prototype storage section 10, based on an input command from the operating section 2. By this deforming processing operation, the schema prototype can be deformed in an arbitrary shape desired by a person who prepares a report.

The paint processing section 111 executes a paint processing operation for applying a predetermined color, a pattern, a symbol, a character or the like to the schema prototype read out from the schema prototype storage section 10 or the schema prototype deformed by the schema prototype deforming processing section 110, based on the input command from the operating section 2. By this paint processing operation, the schema prototype can be applied with an arbitrary color or the like desired by a person who prepares a report.

The cross section preparing section 112 prepares a cross section at an arbitrary position specified by using the operating section 2. This preparation is achieved by using a schema prototype displayed on the display section 3, a report schema, and a prototype of the schema after deformed, the prototype being displayed on the display unit 3 until the report schema has been generated. This cross section can be used as a schema relating to the cross section at the position.

(Schema Editing Function)

Now, a description will be given with respect to a schema editing function that this medical report preparing system 1 has. This function can prepare a detailed schema speedily and easily by deforming a shape of a schema prototype, assigning a pattern or a color, and change it. This processing operation using the editing function (a schema editing processing operation) is carried out by using a single-layered prototype or by using a multi-layered prototype. Hereinafter, a description will be given with respect to a case of using a variety of prototypes.

FIG. 2 is a view for explaining a concept of a schema editing processing operation using a single-layered prototype. This figure shows an example of a schema prototype as a single-layered prototype indicating carotid arteries. As shown in the figure, the schema prototype serving as the single-layered prototype is composed of a graphics having a contour (shape) of carotid arteries. In addition, a plurality of points (dots) discretely allocated along the contour (which are not limited to constant gaps) are displayed in the single-layered prototype.

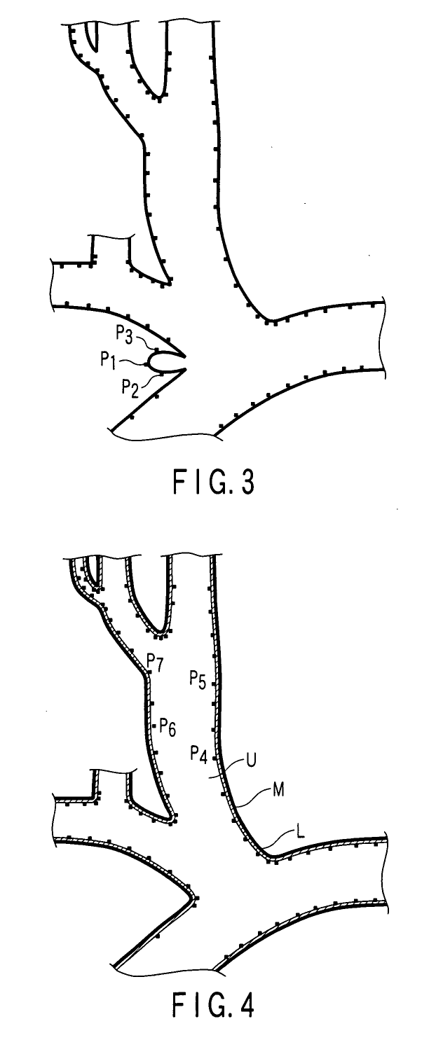

For example, in the case of a person who prepares a report has observed a diagnostic image and judges that an aneurysm exists in the vicinity of point P1, for example, of the schema prototype shown in FIG. 2, the schema having the aneurysm as shown in FIG. 3, for example, can be prepared by making a drag and drop operation for the schema prototype while pointing a cursor to the point P1 or the like. In addition, in the case where a plaque or the like exists at a predetermined position of a blood vessel, a symbol, a predetermined color or the like are applied for the corresponding portion.

In this way, according to schema editing using a single-layered prototype, a schema prototype is edited by deforming a shape using a schema prototype and adding a color or the like to the deformed shape, whereby a desired schema can be prepared speedily and easily.

Now, a description will be given with respect to a schema editing processing operation using a multi-layered prototype. FIG. 4 is a view for explaining a concept of a schema editing processing operation using a multi-layered prototype. This figure shows an example of a schema prototype as a multi-layered prototype indicating carotid arteries. As shown in the figure, a schema prototype serving as a multi-layered prototype has a multi-layered structure having laminated therein a graphics that has a contour (shape) corresponding to carotid arteries, and different colors (or patterns, or alternatively, a combination of colors and patterns) are applied to the graphics of each layer. FIG. 4 illustrates a multi-layered prototype having a triple-layered structure. However, without being limited thereto, the number of laminates in the multi-layered prototype can be set at an arbitrary value by making a predetermined operation from the operating section 2.

This multi-layered prototype is displayed in a mode in which its edge is shifted in small amount so that the colors of layers other than a surface layer can be recognized from each other. In addition, in the multi-layered prototype, a plurality of points (dots) discretely allocated along the contour of a prototype (which are not limited to equal gaps) are displayed in the top layer U.

In addition, in a schema editing processing operation using a multi-layered prototype, respective layers are associated with morphologically, quantitatively, and qualitatively characterizing portions of diagnostic sites (for example, an external wall, an internal membrane, a plaque (hard plaque or soft plaque), an aneurysm, a calcified site, a thickened site, a deformed site or the like). In the present embodiment, exemplified in FIGS. 4, 5A, 5B, 5C and 6, the multi-layered prototype is made of a black bottom layer L, an oblique line layer M, and a white top layer U. The bottom layer L, the middle layer M, and the top layer U are associated with a blood vessel external wall, a plaque (or an area between the blood vessel external wall and a blood vessel internal cavity), and a blood vessel internal cavity, respectively.

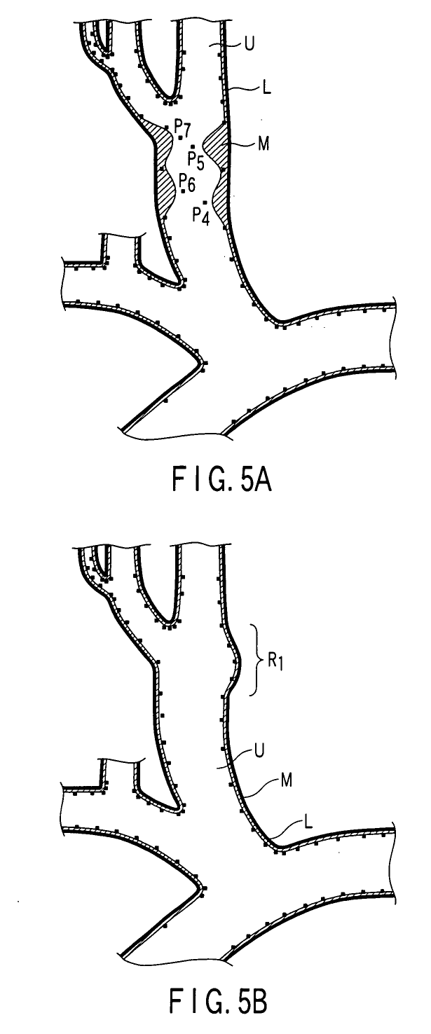

In the case where a person who prepares a report has observed a diagnostic image and judges that a plaque exists in the vicinity of each of P4, P5, P6, and P7, for example, of the schema prototype shown in FIG. 4, the top layer U is turned up from the image while pointing a cursor, for example, to each of the points P4, P5, P6, and P7, by a drag and drop operation or the like, whereby a schema having a display area of the middle layer M corresponding to a plaque shape can be prepared, as shown in FIG. 5A, for example. In addition, with respect to deformation of the blood vessel external wall or blood vessel internal cavity as well, similarly, a layer superimposed on a local layer is turned up or the shape of the graphics of the local layer is deformed, whereby a schema expressing each one of the layers can be prepared. For example, a configuration that a part of the blood vessel swells outside can be depicted by deforming the part R1 corresponding to the part of the blood vessel in the schema prototype outside, as shown in FIG. 5B. For another example, a configuration that a part of the blood vessel is hollow can be depicted by deforming the part R1 corresponding to the part of the blood vessel in the schema prototype inside, as shown in FIG. 5C. Further, colors or patterns different from each other depending on a soft plaque and a hard plaque, for example, are assigned as required, thereby making it possible to discriminate the plaques or the like.

In the foregoing description, a technique for turning up a top layer U of a target layer has been employed in order to change a display area of the target layer. However, there is no limitation to a technique for instructing deformation of the prototype of each layer or the like. For example, a plurality of points are discretely allocated along the contour of each layer of the multi-layered prototype, and these points are applied with a drag and drop operation or the like as well, whereby a similar result can be obtained.

In addition, in schema editing using a multi-layered prototype, a hierarchical relationship between layers can be changed. For example, in FIG. 4, a blood vessel internal cavity (i.e., a blood area) is displayed in the most frontal position on a screen. In such a case, a predetermined operation is made by using the operating section 2, thereby making it possible to change the hierarchical relationship between the layers, for example, making it possible to display the blood vessel external wall in the most frontal position on the screen.

In this manner, according to schema editing using a multi-layered prototype, a desired schema can be prepared speedily and easily by deforming prototypes, each of which is associated with each feature of a diagnostic site.

In addition, deformation points displayed in a schema prototype can be increased or decreased in number in response to its relevant request. This can be achieved by the control section 5 controlling the number of points displayed to be superimposed on the prototype through an entry from the operating section 2, for example. In addition, with a similar configuration, for example, points can be densely applied to divergent portions of a blood vessel, or alternatively, the number of points can be controlled according to the curvature of a contour. Further, it is preferable that a shape deformed by a drag and drop operation of points or the like be corrected by means of spline interpolation or the like in the schema prototype deforming processing section 110, for example, so as to facilitate observation.

In addition, this schema editing function can prepare a cross section at a desired position of the schema in each step of the editing processing operation.

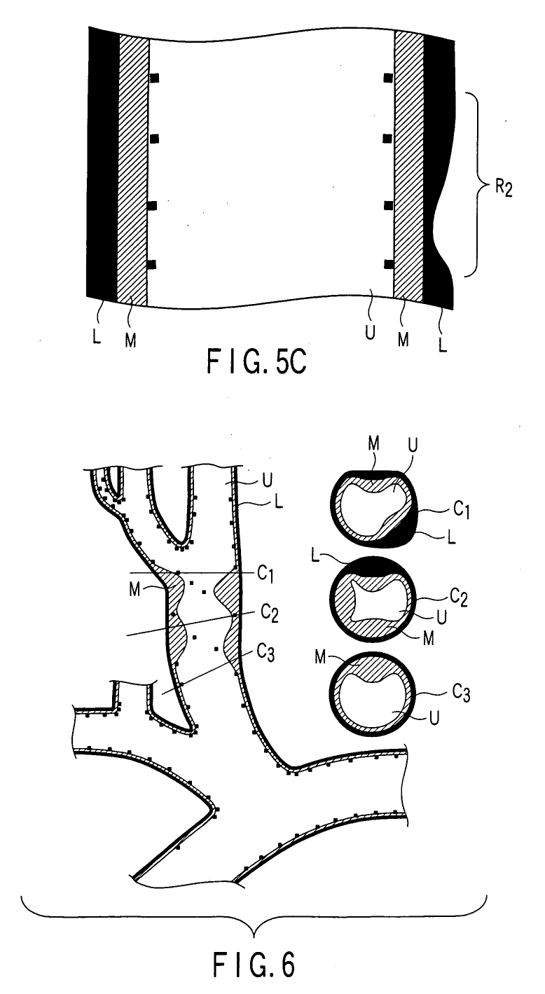

FIG. 6 is a view for explaining a cross section preparing processing operation executed by a schema editing function. This figure shows an example of generating a cross section by using a report schema shown in FIG. 5A. In the figure, C1, C2, and C3 are specified on the report schema relating to carotid arteries by a drag and drop operation or the like from the operating section 2. The cross section preparing section 112 generates a cross section at each of the specified positions by using the report schema. The generated cross section is displayed in the mode shown in FIG. 6, for example, together with the report schema. In addition, this cross section can be entered in or attached to a report as a schema relating to a cross section as required.

Further, in this medical report preparing system, in addition to deformation of the shape of a schema prototype or assignment of color or the like, arbitrary graphics, characters, patterns, colors or the like can be depicted on a schema prototype by means of manual operation via the operating section 2. Depiction of graphics or the like by this manual operation can be used solely or in combination with the schema editing function.

(Operation)

Now, a description will be given with respect to an operation in preparation of a report including a schema editing processing operation of this medical report preparing system 1. For the purpose of a specific description, the present embodiment shows an example of preparing a report by using an ultrasound image acquired by means of an ultrasound diagnostic apparatus. However, without being limited thereto, the present embodiment can be applied even in the case where a report is prepared by using an image acquired by means of medical imaging equipment other than the ultrasound diagnostic apparatus.

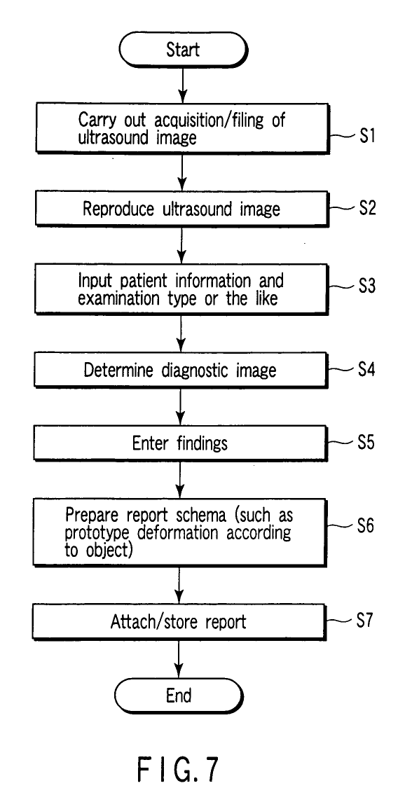

FIG. 7 is a flow chart showing a flow of processing operations executed in preparation of a report including a schema editing processing operation. As shown in the figure, first, an ultrasound image is acquired by using an ultrasound diagnostic apparatus, and the acquired image is stored in an image data storage section 8 via a network (step S1). A doctor who reads an image reproduces an ultrasound image of a predetermined patient (step S2); inputs examination type information including patient information and a diagnostic target site or the like (step S3); and applies a predetermined image processing operation by a command from the operating section. 2, thereby determining a diagnostic image (step S4).

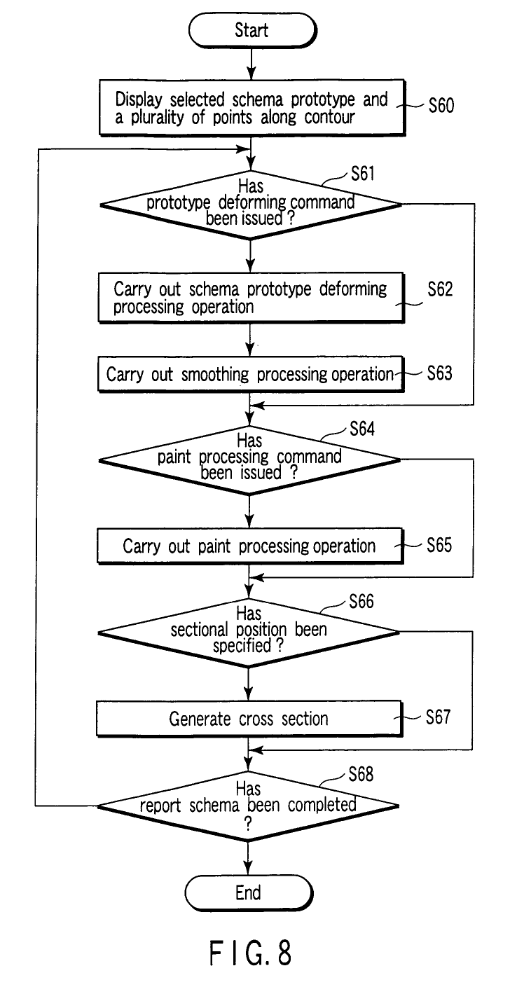

Next, the doctor who reads an image enters an observation result of the diagnostic image as a finding, and then, prepares a report schema by using the schema editing function described previously (step S5 and step S6). FIG. 8 shows an example of flow of preparing a report schema in step S6. In the figure, the contents of the processing operations in steps S60 to S68 are as described previously.

A prepared schema is stored together with a report in a mode in which the schema is described in or attached to the report (step S7).

With the above described configuration, the following advantageous effects can be attained.

In this medical report preparing system, a schema having a desired shape, color or the like is prepared by deforming a schema prototype registered in advance. Therefore, there is no need for manually writing and inputting all items of information while checking a diagnostic image. In addition, there is no need for making a selection from a large amount of patterns as compared with a case of making a selection from a plurality of typical schema patterns, and a more detailed schema can be prepared speedily and easily. As a result, a work load on a person who prepares a report can be reduced and the quality of information on a schema described in or attached to a report can be improved.

In addition, in this medical report preparing system, a schema prototype can be deformed in an arbitrary shape. Thus, this system can be applied even in the case where a diagnostic site has a complicated shape. In addition, a desired color or the like can be assigned to a desired area. Thus, for example, a hard plaque and a soft plaque can be discriminated from each other by colors or the like. As a result, the preparation of a schema corresponding to every disease can be achieved speedily and easily. This benefit is made more significant in combination with depiction of a graphics or the like on a schema prototype through manual operation.

In addition, this medical report preparing system executes the preparation of schemas such that the prototype of each layer is allocated to each of a variety of features such as morphological, quantitative, and qualitative features of a diagnostic target by means of a multi-layered prototype. Therefore, one schema reflecting a variety of findings (diagnostic information) can be entered speedily and easily without complicating each of these findings. As a result, a work load on a person who prepares a report can be reduced and the quality of information on a schema described in or attached to a report can be improved.

Further, this medical report preparing system is capable of generating and displaying a cross sectional shape of a desired position in an arbitrary step of the deforming processing operation. Therefore, an operator can prepare a detailed schema speedily and easily, and can improve the quality of information on a schema described in or attached to a report.

The present invention is not limited to the above described embodiments. At a stage of carrying out the invention, the present invention can be achieved by modifying constituent elements without departing from the spirit of the invention. In addition, a variety of inventions can be formed in accordance with a proper combination of a plurality of constituent elements disclosed in the above described embodiments. For example, some constituent elements may be deleted from all the constituent elements disclosed in the embodiments. Further, the constituent elements over the embodiments different from each other may be properly combined with each other.

What is claimed is:

1. A medical report preparing system, comprising:
a display unit which displays a prototype of a predetermined schema with respect to a variety of diagnostic objects;
an input unit to input a command for deforming the displayed prototype;
a generating unit which generates a report schema by deforming the displayed prototype, based on the command; and
a storage unit which stores the generated report schema to be associated with a medical report.

2. The medical report preparing system according to claim 1, wherein the prototype of the schema has a single-layered structure made of graphics indicating at least shapes of diagnostic objects, and the generating unit generates the report schema by deforming the shapes of the graphics.

3. The medical report preparing system according to claim 1, wherein the prototype of the schema is a graphics that simulates blood vessels of a human body, and
the generating unit generates the report schema, in which a disease of a blood vessel wall is represented, by deformation of the prototype.

4. The medical report preparing system according to claim 1, wherein the prototype of the schema has a multi-layered structure having laminated therein graphics indicating at least shapes of diagnostic objects, and
the generating unit generates the report schema by associating each one of the multiple layers to a characterizing site of a diagnostic object, and then, deforming the shape of the graphics in at least one layer.

5. The medical report preparing system according to claim 1, wherein the respective layers of the multi-layered structure are applied with colors or patterns that are different from each other.

6. The medical report preparing system according to claim 4, further comprising a specifying unit which specifies the number of laminates in the prototype of the schema having a multi-layered structure,
wherein the display unit displays the prototype of the multi-layered structure in accordance with the number of laminates specified by the specifying unit.

7. The medical report preparing system according to claim 4, further comprising a specifying unit which specifies a hierarchical relationship between layers of the multi-layered structure,
wherein the display unit displays the prototype of the schema in accordance with the specified hierarchical relationship.

8. The medical report preparing system according to claim 1, wherein the display unit displays a plurality of points discretely allocated along the shape, and
the generating unit moves at least one of said plurality of points in accordance with a command via the input unit, thereby deforming the displayed prototype.

9. The medical report preparing system according to claim 8, further comprising a specifying unit which specifies the number of said plurality of points discretely allocated along the shape,
wherein the display unit displays said plurality of points discretely allocated along the shape in accordance with the number specified by the specifying unit.

10. The medical report preparing system according to claim 8, wherein the generating unit carries out spline interpolation or any other processing operation for achieving smoothing, after deforming the prototype displayed based on movement of at least one of said plurality of points.

11. The medical report preparing system according to claim 1, wherein the generating unit generates the report schema by applying at least one of predetermined color and pattern to the prototype other than deformation relevant to the displayed prototype.

12. The medical report preparing system according to claim 1, further comprising a specifying unit which specifies a desired position for any one of the prototype of the schema, the report schema, and a prototype of the schema after deformed, the schema being displayed on the display unit until the report schema has been generated,
wherein the generating unit generates a cross section relevant to the specified desired position by using the prototype of the schema, the report schema, and the prototype of the schema after deformed, the schema being displayed on the display unit until the report schema has been generated, and
the display unit displays the generated cross section.

13. The medical report preparing system according to claim 1, further comprising a depicting unit to depict at least any of desired graphics, characters, patterns, and colors to the prototype of the schema by means of manual operation,
wherein the generating unit generates the report schema including at least any of the depicted graphics, characters, patterns, and colors.

14. A medical report preparing method, comprising:
displaying a prototype of a predetermined schema with respect to a variety of diagnostic objects;
generating a report schema by deforming the displayed prototype based on a command for deforming the displayed prototype; and
storing the generated report schema to be associated with a medical report.

15. The medical report preparing method according to claim 14, wherein the prototype of the schema has a single-layered structure made of graphics indicating at least shapes of diagnostic objects, and
the report schema is generated by deforming the shapes of the graphics in generating the report schema.

16. The medical report preparing method according to claim 14, wherein the prototype of the schema is a graphics that simulates blood vessels of a human body, and
the report schema in which a disease of a blood vessel wall is represented is generated by deformation of the prototype in generating the report schema.

17. The medical report preparing method according to claim 14, wherein the prototype of the schema has a multi-layered structure having laminated graphics indicating at least shapes of diagnostic objects thereon, and
the report schema is generated by associating each one of the multiple layers to a characterizing site of a diagnostic object, and then, deforming the shape of the graphics in at least one layer.

18. The medical report preparing method according to claim 14, wherein the respective layers of the multi-layered structure are applied with colors or patterns that are different from each other.

19. The medical report preparing method according to claim 17, wherein the prototype of the multi-layered structure is displayed in accordance with the specified number of laminates in displaying the prototype of the schema.

20. The medical report preparing method according to claim 17, further comprising: specifying a hierarchical relationship between layers of the multi-layered structure,
wherein the prototype of the schema is displayed n accordance with the specified hierarchical relationship in displaying the prototype of the schema.

21. The medical report preparing method according to claim 14, wherein the number of a plurality of points discretely allocated along the shape is displayed in displaying the prototype of the schema, and
the displayed prototype is deformed by moving at least one of said plurality of points in accordance with a command via the input unit.

22. The medical report preparing method according to claim 21, further comprising: specifying the number of said plurality of points discretely allocated along the shape,
wherein said plurality of points discretely allocated along the shape is displayed in accordance with the number specified by the specifying unit, in displaying the prototype of the schema.

23. The medical report preparing method according to claim 21, wherein spline interpolation or any other processing operation for achieving smoothing is carried out after deforming the prototype displayed based on movement of at least one of said plurality of points, in displaying the prototype of the schema.

24. The medical report preparing method according to claim 14, wherein the report schema is generated by applying at least one of predetermined color and pattern to the prototype other than deformation relevant to the displayed prototype, in generating the report schema.

25. The medical report preparing method according to claim 14, further comprising: specifying a desired position for any one of the prototype of the schema, the report schema, and a prototype of the schema after deformed, the schema being displayed on the display unit until the report schema has been generated,
wherein a cross section relevant to the specified desired position is generated by using the prototype of the schema, the report schema, and the prototype of the schema after deformed, in generating the report schema, the schema being displayed on the display unit until the report schema has been generated, and
the generated cross section is displayed in displaying the prototype of the schema.

26. The medical report preparing method according to claim 14, further comprising: depicting at least any of desired graphics, characters, patterns, and colors to the prototype of the schema by means of manual operation,
wherein the report schema including at least any of the depicted graphics, characters, patterns, and colors is generated in generating the report schema.

27. An ultrasound diagnostic apparatus, comprising:
a display unit which displays a prototype of a predetermined schema with respect to a variety of diagnostic objects;
an input unit to input a command for deforming the displayed prototype;
a generating unit which generates a report schema by deforming the displayed prototype, based on the command; and
a storage unit which stores the generated report schema to be associated with a medical report.

28. A system for generating medical report enabling the computer system, comprising:
a computer code device configured to display a prototype of a predetermined schema with respect to a variety of diagnostic objects;
a computer code device configured to input a command for deforming the displayed prototype;
a computer code device configured to generate a report schema by deforming the displayed prototype, based on the command; and
a computer code device configured to store the generated report schema to be associated with a medical report.
